(19) United States
(12) Patent Application Publication
(10) Pub. No.: US 2001/0045687 A1
(43) Pub. Date: Nov. 29, 2001

(54) Insulation of coils

(76) Inventors: Thomas Baumann, Wettingen (CH); Joerg Oesterheld, Birmenstorf (CH); Daniel Schulz, Kilchberg (CH)

Correspondence Address: BURNS DOANE SWECKER & MATHIS L L P, POST OFFICE BOX 1404, ALEXANDRIA, VA, 22313-1404, US

(21) Appl. No.: 09/852,758

(22) Filed: May 11, 2001

(30) Foreign Application Priority Data
May 12, 2000 (DE) 100 23 207.8

(51) Int. Cl. B29C 31/00

(52) U.S. Cl. 264/272.19

(57) ABSTRACT

The invention relates to a method for applying the main insulation of original coil forms, in particular for stator windings, whereby the original coil forms have a rectangular cross-section and the main insulation consists of elastomer.

### BACKGROUND OF THE INVENTION

1. Field of Technology

The invention relates to a method for insulating stator windings for rotating electrical machines, in particular direct current machines and alternating current machines.

2. State of the Art

In general, such electrical machines are provided with a stator and a rotor in order to convert mechanical energy into electrical energy (i.e., a generator) or, vice versa, to convert electrical energy into mechanical energy (i.e., an electric motor). Depending on the operating status of the electrical machine, voltages are generated in the conductors of the stator windings. This means that the conductors of the stator windings must be appropriately insulated in order to avoid a short circuit.

Stator windings in electrical machines can be constructed in different ways. It is possible to bundle several individual conductors that are insulated against one another and to provide the conductor bundle created in this manner, often called a conductor bar, with a so-called main insulation. To produce the stator windings, several conductor bars are connected with each other at their frontal faces. This connection can be made, for example, with a metal plate to which both the respective insulated individual conductors of the first conductor bar as well as the respective insulated conductors of the second conductor bar are connected in a conductive manner. The individual conductors of the conductor bar are therefore not insulated from each other in the area of the metal plate.

Alternatively to bundling the individual conductors into conductor bars, a long, insulated individual conductor is wound to a flat, oval coil that is called an original coil form or “Fish”. In a subsequent process, the so-called spreading, the original coil forms are transformed into their final shape and built into the stator.

With both of the above-described manufacturing techniques, both round and rectangular individual conductors can be used. The conductor bars or original coil forms produced from several individual conductors for the stator windings again may have round or rectangular cross-sections. The invention at hand preferably looks at conductor bars or original coil forms with a rectangular cross-section that were made from rectangular individual conductors. The conductor bars may be manufactured either as Roebel transpositions, i.e., transpositions with individual conductors twisted around each other, or not as Roebel transposition, i.e., transpositions with untwisted, parallel individual conductors.

According to the state of the art, mica paper that has been reinforced with a glass fabric carrier for mechanical reasons, is usually wound tape-like around the conductor in order to insulate the stator windings (e.g., conductor bars, original coil forms, coils). The wound conductor, which may also be shaped after being taped, is then impregnated with a hardening resin, resulting in a duroplastic, non-meltable insulation. Also known are mica-containing insulations with a thermoplastic matrix that are also applied to the conductor in the form of a tape, such as, for example, asphalt, shellac (Brown Boveri Review Vol. 57, p. 15: R. Schuler: “Insulation Systems for High-Voltage Rotating Machines”), polysulfone and polyether ether ketone (DE 43 44044 A1). These insulations can be plastically reshaped when the melting temperature of the matrix is exceeded.

The insulations of stator windings that have been applied by wrapping have the disadvantage that their manufacture is time- and cost-intensive. In this context, special mention should be made of the wrapping process and impregnation process since they cannot be significantly accelerated any further because of the physical properties of the mica paper and impregnation resin. This manufacturing process is particularly prone to defects especially in the case of thick insulations, if the mica paper adapts insufficiently to the stator winding. In particular, an insufficient adjustment of the wrapping machine after wrapping the stator winding may result in wrinkles and tears in the mica paper, for example because of a too steep or flat angle between the mica paper and the conductor, or because of an unsuitable static or dynamic tensile force acting on the mica paper during the wrapping. An excessive tape application may also result in overlaps that prevent uniform impregnation of the insulation in the impregnation tool. This may create a locally or generally defective insulation with reduced short-term or long-term stability. This significantly reduces the life span of such insulations for stator windings.

In addition, manufacturing processes for encasing conductor bundles are known from cable technology, whereby conductor bundles with a round cross-section are always encased with a thermoplast or with elastomers in an extrusion process. Document U.S. Pat. No. 5,650,031, which is related to the same subject matter as WO 97/11831, describes such a process for insulating stator windings in which the stator winding is passed through a central bore of an extruder. The stator winding, which has a complex shape, is hereby encased simultaneously with an extruded thermoplastic material at each side of the complex form, especially by co-extrusion.

Also known from cable technology are polymeric insulations applied to the cables using a hot shrink-on technique. This relates to prefabricated sleeves with a round cross-section of curing thermoplasts, elastomers, polyvinylidene fluoride, PVC, silicone elastomer or Teflon. After fabrication, these materials are stretched in their warm state and cooled. Once cooled, the material retains its stretched shape. This is accomplished, for example, because crystalline centers that fix the stretched macromolecules are formed. After repeated heating beyond the crystalline melting point, the crystalline zones are dissolved, whereby the macromolecules return to their unstretched state, and the insulation is in this way shrunk on. Also known are cold shrink-on sleeves that are mechanically stretched in their cold state. In the stretched state, these sleeves are pulled over a support structure that holds the sleeves permanently in the stretched state. Once the sleeves have been pushed and fixed over the components to be insulated, the support structure is removed in a suitable manner, for example by pulling a spiral, perforated support structure out. But such shrink-on techniques cannot be used for stator windings with a rectangular cross-section since the sleeves with their round cross-section easily tear along the edges of the rectangular conductors, either immediately after shrinking or after being strained briefly while the electrical machine is operated, because of the thermal and mechanical stresses.

Even while the stator windings are being manufactured, especially during the bending and handling of the conductors, particularly during installation into the stator, the insulation must be able to bear a significant high mechanical stress which could damage the insulation of the stator windings. The insulation of the stator winding conductors is also exposed to a combined stress during operation of the electrical machine. On the one hand, the insulation is dielectrically stressed between the conductor, to which a high voltage is applied, and the stator, by a resulting electrical field. On the other hand, the heat generated in the conductor exposes the insulation to a thermal alternating stress, whereby a high temperature gradient is present in the insulation while the machine passes through the respective operating states. Because the involved materials expand differently, mechanical alternating stresses also occur. This results both in a shearing stress of the bond between conductor and insulation and a risk of abrasion at the interface between insulation and slot wall of the stator. Because of these high stresses, the insulation of the stator windings may tear, resulting in a short circuit. Consequently, the entire electrical machine will fail, and the repair will be time- and cost-intensive.

### SUMMARY OF THE INVENTION

This is the starting point for the invention. The invention is based on the objective of creating a process for insulating stator windings for rotating electrical machines, whereby insulated stator windings are produced that ensure the insulation of the stator winding over the intended life span of the electrical machine.

The invention utilizes the fact that the elastomer is highly elastic, yet is able to withstand high thermal and electrical stresses. In the case of higher thermal stresses, silicone elastomer can be used advantageously. It is advantageous that the main insulation is applied to original coil forms with a rectangular cross-section.

In a particularly preferred method, the original coil forms are only brought into their final shape after being encased with the elastomer. The bending of the involutes greatly stretches the applied insulation. The use of elastomer according to the invention is hereby found to be particularly advantageous, since it reduces or even completely avoids the adverse mechanical, electrical or thermal effects on the insulation that is being stressed by bending.

Elastomers as a material for the main insulation promote the application of an injection molding process. The individual parts of the injection mold are preferably constructed in a modular manner for covering the original coil form geometries that occur more frequently.

It is preferred that the original coil forms are centered with spacer elements or adjustable mandrels in the casting mold. The centering must be accomplished in such a way that the void between conductor bar and casting form has the same height at any point. The scope of this invention also includes providing main insulations with different thicknesses around the original coil form. A uniform thickness of the main insulation is, however, a preferred embodiment.

### BRIEF DESCRIPTION OF THE DRAWINGS

The invention is described in more detail below with reference to the drawings, using exemplary embodiments.

FIG 1a shows a cross-section through an injection mold in which two arms of an original coil form are centered by spacer elements in the casting mold;

FIG. 1b shows a longitudinal section through an injection mold in which an original coil form is centered by spacer elements in the casting mold;

FIG. 1c shows a longitudinal section through an injection mold in which an original coil form is centered by spacer elements with different shapes in the casting mold;

FIG. 2a shows a cross-section through an injection mold in which two original coil forms are centered by adjustable mandrels in the casting mold;

FIG. 2b shows a longitudinal section through an injection mold in which one original coil form is centered by adjustable mandrels in the casting mold;

FIG. 3 shows a detail of the adjustable mandrel in FIG. 2b; and,

FIG. 4a shows an extrusion device; and,

FIG. 4b shows an original coil form in an extrusion device.

### DESCRIPTION OF THE PREFERRED EMBODIMENTS

The figures only show the elements and components essential for understanding the invention. The shown methods and devices according to the invention therefore can be supplemented in many ways or can be modified in a manner obvious to one skilled in the art, without abandoning or changing the concept of the invention.

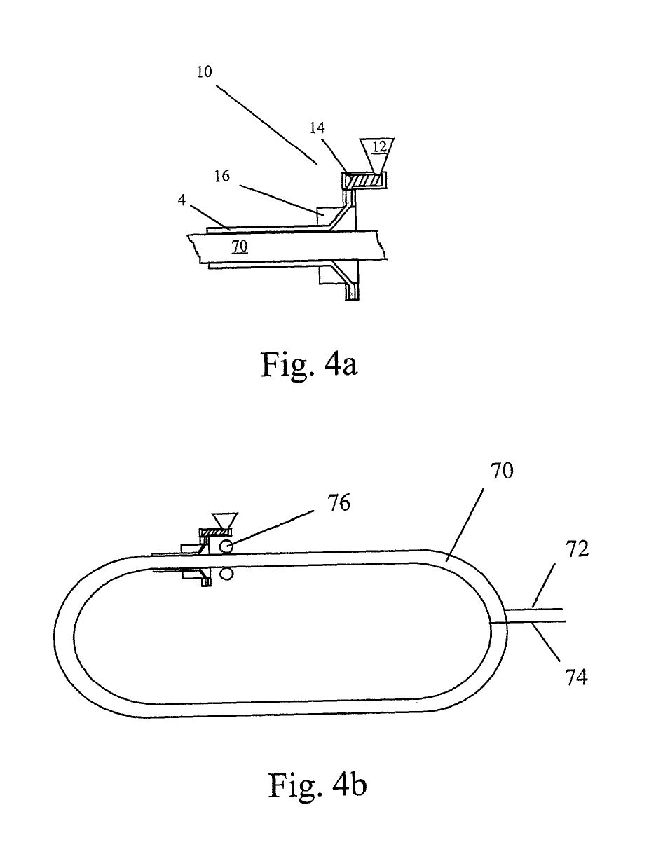

FIG. 4b shows an original coil form 70 that is provided in an extrusion process with a main insulation. Original coil forms are manufactured by wrapping a long, insulated individual conductor into a planar, oval coil. The beginning of the long insulated conductor may be used, for example, as a coil input line 72, while the end of the conductor then is used as the coil output line 74. In a subsequent process, the so-called spreading, the original coil forms or fishes are transformed into their final shape and built into the stator.

To manufacture original coil forms 70, both round and rectangular individual conductors can be used. The original coil forms 70 produced for the stator windings from an individual conductor again may have round or rectangular cross-sections. The invention at hand preferably looks at original coil forms 70 with a rectangular cross-section that preferably were made from an individual conductor. When using rectangular cross-sections, the advantages of the invention are also realized when the cross-section of the individual conductor and/or of the original coil form 70 slightly deviate from the rectangular shape.

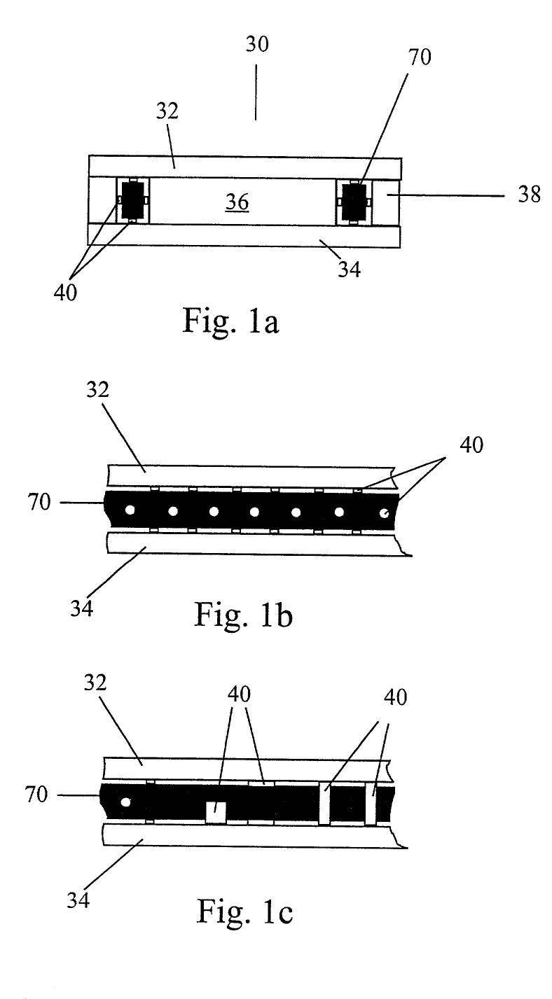

FIG. 1a shows the cross-section through an injection mold 30 in which two arms of an original coil form 70 are centered by spacer elements 40 in the mold chambers. The injection mold 30 consists of a cover 32 and a bottom plate 34. Between two mold chambers, a center part 36 is provided, which forms a side wall of each of one of the adjoining mold chambers. The other two side walls of the two mold chambers are formed by edge parts 38. The drawing shows the two arms of an original coil form. The injection molds, which are open at their ends, only enclose part of the original coil form 70.

The injection mold 30 of FIG. 1a shows two mold chambers. The number of mold chambers per injection mold can be varied at any time, however. A reduction to one casting mold is achieved, for example, by removing the center part 36 and moving at least one of the two edge parts 38 in the direction of the other edge part. On the other hand, the number of mold chambers can be increased by using, for example, several center parts 36 with reduced width. In this way, the center part 36 shown in FIG. 1a can be replaced with two narrower center parts, between which another casting mold is formed.

The geometrical dimensions of the individual parts of the injection mold 30, i.e., in particular cover 32, bottom plate 34, center part(s) 36, and edge parts 38, can be varied in such a manner that they form elements of a modular system and in this way cover a variety of possible coil geometries (cross-section, length, radii). The use of center parts 36 and edge parts 38 with different heights, while retaining the same geometrical extensions of the injection mold, makes it possible to coat original coil forms with different cross-sections, for example original coil forms 70 having the same width but different heights. Alternatively, one arm of an original coil form of corresponding height which is twisted by 90° around its longitudinal axis can be placed into the casting mold in order to coat original coil forms 70 of identical height but different widths. Smaller variations in the coil cross-section can also be compensated by greater layer thicknesses of the main insulation to be cast. A variety of different cross-sections of original coil forms can be coated by combining center parts 36 and edge parts 38 with different heights with center parts 36 and edge parts 38 with different widths. The flexibility of the modular system for the injection molds can also be increased by using spacer plates. These plates can be provided advantageously at the side, bottom or ceiling plates of the mold chambers in order to reduce the width or height of the mold chamber.

In a preferred embodiment, the insulation thicknesses are identical on the narrow and wide sides of the conductor coil. In a particularly advantageous embodiment, the insulation thickness is greater on the narrow sides of the conductors than on the wide sides, so that the electrical field elevation is reduced at the conductor edges without hindering the dissipation of heat via the wide side.

In another embodiment (not shown), injection molds are provided that can be used to apply a main insulation to already bent sections of the conductor coil. For this purpose, the injection mold has three-dimensionally shaped sections that preferably can be adapted to certain tolerances of the conductor coil. A standardization of the radii is recommended. Depending on the geometry of the original coil form, the injection mold can be composed of components of a modular system, which clearly lowers the costs for injection molds. Part of the advantages gained by using simple and cheap injection molds are lost with the injection molds designed for bent conductor coils. Nevertheless, this can be compensated for, for large volumes, especially if the molds adapted to already bent conductor coils can be used for several types as a result of standardization.

The complicated molds are also justified when insulation and external corona shielding can be applied in one step. This can be accomplished, for example, with movable sections used to apply the layers by injecting, curing, moving the section, injecting, curing, etc. Alternatively, a multishot injection molding process can be used.

FIG. 1b shows a longitudinal section through one of the mold chambers shown in FIG. 1a. The cylindrical spacer elements 40 hereby normally center one arm of the original coil form 70 in such a way in the mold chamber that the layer thickness of the main insulation has the same height on all sides. By using spacer elements with different heights, a main insulation with a varying layer thickness can be applied around the original coil form 70, if needed. It is hereby not necessary that cylindrical spacer elements 40 are used. Spacer elements with a square or rectangular cross-section fulfill the same purpose, but facilitate the spacing of the coil from the side walls since they can be placed with one of their narrow sides onto the bottom of the casting mold without rolling off. FIG. 1c shows spacer elements 40 with a rectangular cross-section. Alternatively to this, spacer elements that completely enclose the original coil form can be used. It is preferred that completely enclosing spacer elements 40 are cut open on one of their sides so that they can be placed more easily around the coil.

The centering of the coil in the mold chamber (given a main insulation with identical layer thickness) or the spacing of the coil from the individual walls of the mold chamber is accomplished, as already mentioned, by using spacer bars 40 with different shapes and heights which are placed at a suitable distance from each other onto the coil or into the mold chamber. It is preferred that the spacer elements are made from the same material as the main insulation. The spacer elements are provided with a certain dimensional stability by partially curing the material. On the other hand, they still have sufficient reactive bonds, however, to be able to form a tight chemical bond with the cast material of the main insulation. Depending on the material used, simple trials can be conducted to establish the degree of curing that must be present in the material of the spacer elements so that the same or equivalent mechanical and electrical strengths can be obtained at the interfaces as in the homogenous material of the main insulation that does not have any interfaces.

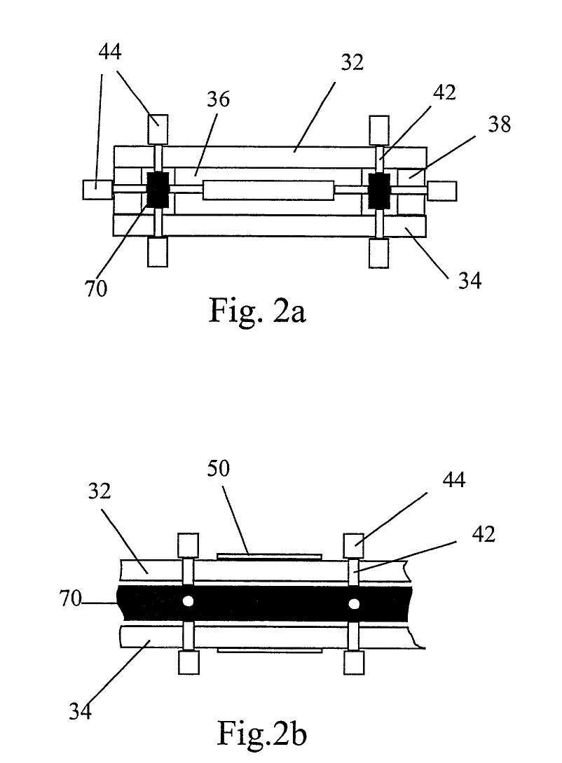

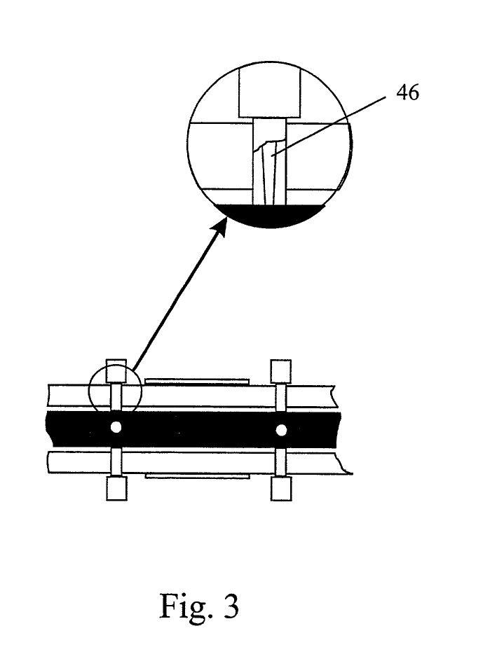

In FIG. 2a and b, adjustable mandrels 42 are used to center two arms of an original coil form 70 within the mold chamber of the injection mold or to space them from the walls of the mold chamber. A control element 44 permits a precise adjustment of the individual mandrels 42, which also can be moved in a defined manner when the injection mold is closed. During the injection process of the elastomer and the initial curing, the coils are held by the mandrels in the desired position. As curing progresses, the elastomer injected as material for the main insulation reaches a firmness that holds the coil in its desired position even without the mandrels. After the main insulation has reached this firmness, the mandrels 42 are withdrawn, and the resulting voids are filled with liquid elastomer. The liquid material is injected into the voids through the injection channels 46 (see FIG. 3) inside the mandrels 42. The material injected in the area of the mandrels can be in liquid or gel form, but must still have sufficient reactive bonds so that the mechanical and electrical properties of the main insulation at the interface correspond to those of the homogenous material of the main insulation. The adjoining material around the mandrel may already be firm yet must still be reactive. To promote the curing at the interface, a heating region 50 may be provided, for example, between two spacer mandrels (see FIG. 2b). In this way, the heat and thus the curing front spreads starting from the heating region in the direction of the mandrels so that the start of curing is delayed, and the material near the mandrels therefore is still able to sufficiently react with the elastomer freshly supplied through the injection channel 46. As an alternative or additionally to this, the mandrels 42 can be cooled. This cooling makes it possible for the material in and around the mandrel not to cure yet.

The injection molds shown in FIG. 1 and 2 preferably are designed open at their longitudinal ends and are closed off with sealing caps that enclose the original coil form in a pressure-proof manner. In order to insulate the original coil form 70 along its entire length, the main insulation also may be applied in one or more steps, or several injection molds of the modular system are put together to form a partial or complete injection mold. The seams created in this way can be constructed according to the above described curing process. This also ensures that the required material properties are present at the seams.

FIG. 4a shows an extruder 10 that continuously presses the material to be processed, i.e., the elastomer, as a molding material in the plasticized state from a pressure chamber via an appropriately profiled extruder tool through a nozzle to the outside. This creates a rectangular sleeve in the form of an infinite strand that encapsulates the original coil form 70 as an insulating layer 4. The raw material (for example in the form of a caoutchouc strip from the roller, as granules or as powder) is fed through a charging attachment 12 into a conversion area 14, in which it is condensed, preheated, and converted to a plasticized molding mass. The transport within the conversion area 14 is achieved, for example, by using a screw. A reshaping tool 16 performs the subsequent shaping of the material sleeve to a rectangular cross-section. Both an extruder head with a round cross-section in the inlet area (and subsequent reshaping) as well as an extruder that already has a rectangular cross-section in the material inlet area can be used. The material properties of the main insulation can be adjusted in such a way by adding active (e.g., silicic acid) and passive (e.g., quartz sand) fillers that they fulfill the respective mechanical requirements of the electrical machines into which the stator windings provided with the main insulation are installed.

FIG. 4b shows an original coil form 70 inside the extruder. In the case of not too small radii of the narrow sides of the original coil form, the extrusion process can be performed continuously around the entire original coil form. The extruder head must be constructed so that it can be placed around the original coil form (see, for example, DE 43 26 650 A1) since a closed coil is not guided into the extruder head from one side analogously to an individual conductor or conductor bar. A corresponding design of the extruder head (cf. U.S. Pat. No. 5,650,031) also permits an encapsulation of the curvature of the original coil form. In this case, it is advantageous that the extruder head is attached to one side of the original coil form (for example at the coil output line 74) and is guided along the original coil form to its other end (coil input line 72).

Pressure rollers 76 located upstream from the extruder hold the individual conductors of the original coil form tightly together in order to permit a uniform, void-free encapsulation of the original coil form with the main insulation. Other possibilities of holding the individual conductors of the original coil form tightly together include, for example, a temporary bonding of the individual conductors with an elastic material or an adhesive that is mechanically weak in relation to shearing forces, so that the later bending (spreading) of the coil is not hindered. Alternatively, an adhesive can be used that loses its adhesive power when moderately heated (for example prior to spreading) and therefore promotes the bending process. These measures also can be used advantageously for injection molding processes.

In some applications, it is preferred that the original coil forms 70 are provided with slot corona shielding and termination (yoke corona shielding). The slot or external corona shielding of a stator winding is usually a conductive material layer located between the main insulation and the stator slot. The external corona shielding, which creates a defined potential layer, is supposed to prevent electrical discharges that can be caused, for example, by varying distances of the high potential insulated coil from the grounded stator nut. Options for applying such protective layers within the scope of this invention include, for example, conductive or semi-conductive finishes on elastomer basis, corresponding tapes (possibly self-fusing), which can be cured by irradiation or heat. Alternatively, cold- or heat-shrink-on cuffs can be used. Principally, flowable, plastic materials also can be used for the external corona shielding.

In another preferred embodiment of the method, main insulation and/or external corona shielding are applied with the help of several consecutive injection molding processes or by double or triple co-extrusion. In the case of the injection molding process, this may be accomplished in different injection molds with different cross-sections or in the same mold, whereby the mold chamber is then provided during the corresponding injection molding steps with filler profiles (spacer plates) in order to leave room for the next layer. It is also possible to provide the mold chamber with movable sections. Movable sections are part of a casting mold that can be arranged so that an additional layer is injected, for example, only in the area of the termination (slot corona shielding end to termination end).

The slot corona shielding layer preferably is only applied in the area of the bar that later comes to rest inside the slot. The yoke corona shielding for preventing peak discharges at the end of the slot corona shielding can be applied using the already mentioned processes.

In a spreading device (not shown) that has been modified from the state of the art, the original coil form is brought into a shape suitable for installation into the stator. Parts of the insulated original coil form are placed into the gripping jaws of the bending device and are bent there by moving the gripping jaws in relation to the radial tools. Between the radial tools and the main insulation of the original coil form is a protective layer that distributes the pressure generated by the radial tools over the surface and in this way prevents an excessive pinching of the insulation layer. The uniformly distributed mechanical stress on the elastomer insulation layer prevents damage. The bending of the involute causes very high tensile forces in the insulation layer that, in the case of standard materials, such as high-temperature thermoplasts, lead to breaks in the insulation layer. Polyethylene would have the necessary flexibility, but does not have the temperature stability required for typical electrical machines, but could in principle be used in a similar manner for machines with low thermal utilization (T<90° C.). The same holds true for other flexible thermoplasts.

A cross-section through the original coil form shows a bundle of individual conductors. A bending of the original coil form already provided with the main insulation causes both a relative movement of the individual conductors against each other as well as a relative movement of the individual conductors at the surface of the original coil form against the main insulation. It is advantageous that the interface between original coil form and main insulation has properties that enable a shifting of the individual conductors relative to the main insulation with reduced friction. This may be achieved, for example, by treating the conductor bar with separating agents. Without internal corona shielding, the shifting is, in most cases, uncritical because the field is reduced in the bend area (following the termination).

An elastomer is used as a material for the main insulation. The elastomer is characterized by high elasticity. It also has a high electrical and thermal stability. In particular, for thermally highly stressed machines, it is preferred that silicone elastomers are used. Especially the advantageous use of elastomer (in contrast to other materials) permits the use of injection molding or extrusion processes and fulfills the high requirements for the resistance of the material and its mechanical flexibility. The elastomers may be cold- or hot-curing types. The curing for cold-curing types is initiated, for example, by mixing two components, whereby one of the components contains a curing agent. In the case of hot-curing types, the elastomer can be heated already in the injection mold and/or after the encasing of the original coil form 70. The latter is done preferably with hot air (oven) or by a resistive or inductive heating of the original coil form.

1. Method for applying the main insulation of original coil forms, in particular, for stator windings, whereby the original coil forms have a rectangular cross-section and main insulation consists of elastomer.

2. Method as claimed in claim 1, whereby the encapsulation is performed with a silicone elastomer.

3. Method as claimed in claim 1, whereby the encapsulation is performed by extrusion.

4. Method as claimed in claim 1, whereby the encapsulation is performed by an injection molding process.

5. Method as claimed in claim 1, whereby the original coil form is transformed by spreading into another shape.

6. Method as claimed in claim 1, whereby original coil forms consisting of individual conductors are used, whereby the individual conductors preferably have a rectangular cross-section.

7. Method as claimed in claim 6, whereby the individual conductors are temporarily connected to each other.

8. Method as claimed in claim 1, whereby the main insulation is applied with the same thickness on all sides.

9. Method as claimed in claim 1, whereby the main insulation is applied thicker on the narrow side than on the wide side.

10. Insulated original coil forms or coils for stator windings, manufactured according to the method of claim 1.
